(19) United States
(12) Patent Application Publication
(10) Pub. No.: US 2009/0246241 A1
(43) Pub. Date: Oct. 1, 2009

(54) Animal pest repellant device

(76) Inventor: Kathleen Pitt, Morristown, NJ (US)

Correspondence Address: GEARHART LAW, LLC, 4 FERNDALE ROAD, CHATHAM, NJ, 07928, US

(21) Appl. No.: 12/383,484

(22) Filed: Mar. 25, 2009

Related U.S. Application Data
(60) Provisional application No. 61/070,922, filed on Mar. 26, 2008.
(60) Provisional application No. 61/127,003, filed on May 10, 2008.
(60) Provisional application No. 61/127,157, filed on May 10, 2008.

(51) Int. Cl. A01N 25/34

(52) U.S. Cl. 424/410; 424/411

(57) ABSTRACT

An article of manufacture, comprising: an animal repellant dispersed over an artificial plant structure. The artificial plant structure may be a whole artificial plant or an artificial plant portion. The invention is also an article of manufacture comprising a band, wherein the band has an animal repellant or insect repellent disposed thereon. The band is suitable for wrapping a garden fixture or garden article. The band could also be worn by a human to repel insects when the band has insect repellent disposed thereon.

### CLAIM OF PRIORITY

This application claims priority to U.S. Ser. No. 61/070,922 filed Mar. 26, 2008, U.S. Ser. No. 61/127,003 filed May 10, 2008, and U.S. Ser. No. 61/127,157 filed May 10, 2008 all such application being incorporated herein by reference.

### FIELD OF THE INVENTION

The present invention relates to devices that prevents or reduces the destruction of plants by pest animals or insects.

### BACKGROUND OF THE INVENTION

In many areas portions of the country, deer populations have grown at an enormous rate over the years. In some regions, their numbers have grown so quickly that they are no longer intimidated by human populations. Consequently, deer have become major pest to landscapers and gardeners, consuming expensive plants and flowers. The following invention is a way for landowners to safely repel deer, without having to hunt or otherwise endanger them.

There are several well-known strategies to repel deer through scent. One effective mechanism is to create the smell of danger. Products on the market today are typically predator feces or urine and dried blood all of which will set off a “predator alert”. The second method of deterrent through scent is overwhelming their sense of smell—preferably with orders they find unpleasant. By “jamming” a deer's sense of smell, they cannot sense a predator through olfactory function. A third well known strategy is taste. A fourth is texture.

The two high priorities of deer on daily basis are to not get eaten and to eat. To do both requires good olfactory function. Glands on a deer's body release various scents that other deer “read” and interpret. Interdigital scent glands (between the toes) release scent wherever the deer walks. Other deer read theses scent trails as the “all clear” for danger, or “all clear” to forage and find food. Conversely a frightened deer gives off a distinct odor-other deer coming into the same area as a frightened deer, even hours later, show definite signs of distress.

The deer is a creature of habit, typically inhabiting a one mile radius. Deer graze unfazed close to 65 mile per hour highways. Deer will feed next to noisy campgrounds unfazed. This is because once deer have accepted a sight, smell or sound as unthreatening/normal they will ignore it.

Preventing potential deer damage has a higher success rate than altering existing habits. Early spring is the optimum time to set up deer deterrents. Product repellents need to be intense in order to prohibit the deer by sensing danger. Losing this sense of smell, by overpowering it with another, has proven to be intolerable for deer. Predator alert deterrents offer a more direct approach and are more effective when used properly. These scents, in contrast to blocking out the ability to smell danger, indicate danger for the deer.

Deer get used to order. Therefore, it is important to not only keep changing product line deterrents and the scents associated with them, but to also change the locations of the deterrent.

### Description of Related Art

Patent WO2002043537 teaches novel methods, apparatus and kits are provided to develop a new presently-untapped market for state-of-the-art artificial flowers presently sold only as part artificial flower plant assemblies that include artificial stems, branches leaves, etc., the invention comprising various novel improved means, as well as kits including such means, for attaching such artificial flowers to non-blooming (pre-bloom, post-bloom, or never-bloom) live vegetation having live stems, branches, leaves, etc., to simulate blooming thereof, for easy care-free instant yard beautification, said flowers being preferably, but not necessarily, devoid of artificial plant stems, branches leaves, etc., for kit cost reduction and improved simulation.

U.S. Pat. No. 2,514,177 teaches an artificial flower attachment. This invention relates to a holder and the primary object of the invention is to provide means for mounting artificial flowers on living foliage so that it will simulate blooming flowers as closely as possible.

U.S. Pat. No. 2,881,545 teaches artificial flowers. This method allows, after mounting, obtaining a flower comprising a large number of petals placed on one or several rows while at the same time using a single corolla which has all the petals molded in one single injection.

U.S. Pat. No. 2,984,036 teaches artificial garland construction which is characterized by a greater degree of flexibility than has heretofore been attainable with such structures whereby certain unique advantages are achieved.

U.S. Pat. No. 3,041,766 teaches an artificial flower structure fabricated in accordance with the present invention and includes a main stem having extending therefrom a plurality of leaf-bearing stems. These leaf-bearing stems include a notched portion for engaging an armature wire extending through the main stem, which is substantially tubular throughout, for properly orienting the leaf-bearing stems with respect to the main stem. A slidable sleeve is mounted on the main stem so that it may be shifted to a position whereby it will function to fix the leaf-bearing stems to this main stem. One end of the main stem may mount a flower simulating structure which comprises a one-piece member suitably molded to represent, when assembled with other prefabricated parts of this flower structure, a flower. This one-piece member includes petal-simulating sections and stem sections, the latter sections being cooperable with a ring-shaped member, which may form part of a flower calyx or part of a flower corolla, for correctly positioning the petal sections. The armature wire employed for orienting the leaf-bearing stems additionally cooperates with the one-piece member simulating a flower corolla for attaching the flower structure to the main stem.

U.S. Pat. No. 3,050,619 relates to portable electrically lighted outfits such as used in decorative displays for Christmas trees, for stringing about door and window trim, and for other ornamental illumination purposes. More particularly, the invention is directed to improvements in lighted floral displays whereby removable attachment of translucent floral units to electric light sockets may be readily accomplished.

U.S. Pat. No. 3,137,610 teaches artificial flower construction of the type in which molded plastic components are separately formed and then assembled one against another to simulate the several parts of a flower or blossom as they appear growing on a branch or stem of a plant.

U.S. Pat. No. 3,309,258 teaches flower chain holder which is especially constructed and arranged for the rapid and efficient assembly thereon of a series of Rower bud and leaf spray units.

U.S. Pat. No. 3,452,476 teaches a connecting means for purposes of attaching a natural flower to an artificial supporting stem-like means to facilitate florists in preparing various types of-floral arrangements and bouquets with minimum effort and consumption of time to provide the scent of natural flowers therein. Essentially, the connecting means is a member having piercing means to penetrate and interlock with the calyx of a natural flower and also having attaching means engageable with artificial supporting stem-like means.

U.S. Pat. No. 4,816,301 teaches an artificial representation of a plant formed of plant organ simulating members, such as, stem and leaf simulating members, respectively having rod-like and tubular connecting portions molded of synthetic resin and being axially interengaged to provide a joint for assembling together the respective plant organ simulating members; each tubular connecting portion has an axial bore with an opening at least at one end of the axial insertion of the respective rod-like connecting portion therein and a seating surface extending outwardly from the bore and facing away from the open one end of the latter at a location spaced axially from that one end; and each rod-like connecting portion has a free end with a barb extending therefrom which is flexed inwardly from an original configuration upon the axial insertion of the respective rod-like connecting portion into the bore and which returns to its original configuration upon attaining the location of the seating surface for engaging the latter and thereby locking together the interengaged plant organ simulated members.

U.S. Pat. No. 5,104,467 teaches a mechanism and related processes for joining naturally grown and artificially produced parts to create aesthetically appealing, naturally appearing, large artificial plants, such as trees. A novel joint mechanism provides the appearance of naturally occurring outgrowth of branches and the like from proximally disposed trunks and stems. A method for bending and forming artificial foliage provides a more airy, naturally appearing leaf pattern around the crown of a plant.

U.S. Pat. No. 5,221,565 teaches a mechanism and related processes for joining naturally grown and artificially produced parts to create aesthetically appealing, naturally appearing, large artificial plants, such as trees. A novel joint mechanism provides the appearance of naturally occurring outgrowth of branches and the like from proximally disposed trunks and stems. A method for bending and forming artificial foliage provides a more airy, naturally appearing leaf pattern around the crown of a plant.

U.S. Pat. No. 5,733,612 teaches an artificial flower arrangement kit including a flower matching template with separate, full scale pictorial representations of the flowers to be utilized in the kit and a matching numeral associated with each pictorial representation wherein the matching numeral corresponds to a placement numeral associated with a placement marking on a placement template. The placement template is sized for placement on an upper surface of a foam block into which the flowers are to be inserted through the placement template. The pictorial representations are preferably arranged on the matching template in ascending order corresponding with the order in which the flowers are to be inserted into the mounting block.

U.S. Pat. No. 6,017,596 teaches a kit and method for producing scent emitting artificial flower type articles. The inventive device includes an elongate first stem member and an elongate second stem member that is insertable into the first stem member. A first fringe member has an attachment portion at one end and a plurality of strips that extend from the other end to the attachment portion. A second fringe member has a plurality of first strips and second strips that each extend from a respective end of the second fringe member towards an attachment portion that is positioned between the ends of the second fringe member. A plurality of leaf members each have a leaf-shaped portion that extends from an elongate attachment portion. A third fringe member has an attachment portion at one end and a plurality of strips that extend from the other end towards the attachment portion. A porous strip receives scent emitting liquid. A scent emitting liquid may also be provided.

None of the prior art teaches combining animal repellant with artificial plant structures for the purpose of repelling pest animals. None of the prior art taught combining animal repellant with bands wrapped around garden fixtures such as planters or articles, such as windsocks, for the purpose of repelling pest animals or insects. The invention also discloses a band, which can contain insect repellent and can be worn by a human.

Several embodiments of this invention is illustrated in the accompanying drawings and will be described in more detail herein below.

### SUMMARY OF THE INVENTION

The invention is an article of manufacture which comprises an animal repellant dispersed over an artificial plant structure. The artificial plant structure may be a whole artificial plant or an artificial plant portion. The artificial plant portion may be then affixed to a living plant. The invention, in another form is a band suitable for wrapping a planter, wherein the band has an animal repellant or insect repellent disposed thereon. The band is suitable for wrapping a garden fixture or garden article. The band could also be worn by a human to repel insects when the band has insect repellent disposed thereon.

### BRIEF DESCRIPTION OF THE DRAWINGS

FIG. 1 is a front perspective view of the invention as a full-sized artificial plant staked in ground in comparison with a full-sized natural plant.

FIG. 2 is a front perspective view of the invention as an artificial plant portion that is attached to a living plant portion.

FIG. 3 is a front perspective view of the invention as an artificial plant portion comprising a branch, some twigs and some leaves.

FIG. 4 is a front perspective view of the invention as an artificial plant portion comprising a twig, a leaf, and animal repellant disposed on the leaf.

FIG. 5 is a front perspective view of the invention as an artificial plant portion comprising a twig, a leaf, and animal repellant disposed on the leaf, where the leaf is attached to a plant.

FIG. 6 is a front perspective view of the invention as a band that goes all the way around a planter.

### DESCRIPTION OF THE PREFERRED EMBODIMENTS

The preferred embodiments of the present invention will now be described with reference to the drawings. Identical elements in the various figures are identified with the same reference numerals.

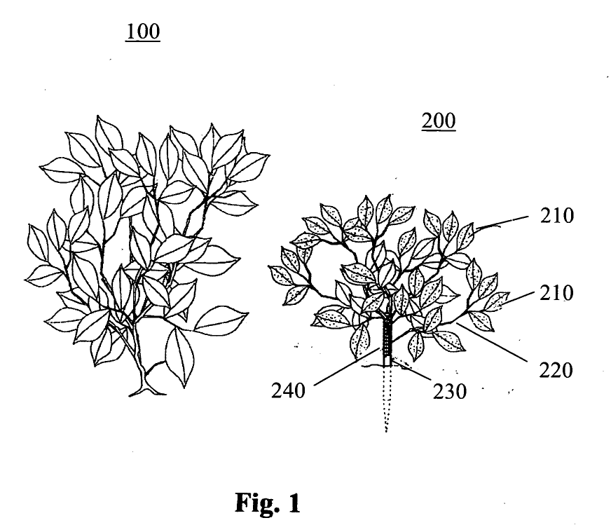

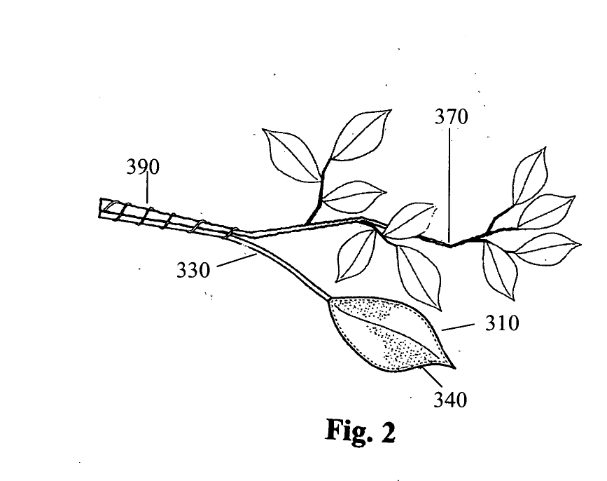

FIG. 1 shows a full-sized artificial plant structure 200 staked in the ground with a full-sized living plant 100 for comparison. As used herein, the term “artificial plant structure” can mean a full sized plant or artificial structure that represents a portion of a natural plant as seen in FIG. 2 to 5. The artificial plant structure 200 may be made of any combination of plastic, wood or metal components. The purpose of the artificial plant 200 is to blend in with the surrounding foliage and to be as indistinguishable from the other foliage as possible. The artificial plant structure 200 is placed in a garden or landscaping scheme where the user desires to repel the pests described herein.

As can be seen in FIG. 1, the artificial plant 200 has artificial plant leaves 210, artificial branches 220 attached to stake 230. Artificial branches 220 with artificial leaves 210 are in FIG. 1 attached to stake 230 with twine or wire 240. The configuration shown in FIG. 1 is only one possible configuration of the invention and the skilled artisan will readily appreciate that artificial plant 200 can be manufactured as a single unit. For example, the artificial plant 200 could have branches made with plastic coated wire that allows them to bend into a particular configuration suitable for attaching the plant portion directly to a natural plant.

Artificial leaves 210 can be made of any absorbent material suitable for containing and/or carrying animal repellent. One highly preferred material is dryer sheet, which when appropriately treated is known to repel deer. The dryer sheet is preferably colored to resemble a natural leaf or branch, and can be green, brown, yellow or can include fall colors such as orange or red depending on the season. In a preferred embodiment, the wire can be bent into the shape of a leaf. The wire frame is covered with dryer sheet or another material suitable for retaining the animal repellant. In an alternate embodiment artificial leaves 210 can be cloth, fabric, paper, foam, or other material that absorbs animal repellent. The animal repellent can be sprayed, dipped, painted, or otherwise applied onto the leaves.

Animal repellant is dispersed over the full-sized artificial plant 200, or it can be dispersed on artificial leaves 210. Generally, the animal repellant may be dispersed over at least 10%, preferably at least 50% of the full-sized artificial plant 200. Animal repellent may be pre-dispersed over the full-sized artificial plant 200. By “pre-dispersed”, it is meant that the animal repellent is applied to the artificial plant at the factory or point-of-sale. In other embodiments, the user may apply the animal repellent to the full-sized artificial plant 200. Methods of user application of animal repellant include but are not limited to spraying, dipping, or painting. In yet another embodiment, the full-sized artificial plant 200 may made of edible materials that the pest animals find unpleasant, distasteful or unpleasing to their senses. (See below.) The animal repellent may be deer repellant, coyote repellant, fox repellant, rodent repellant or insect repellant, or any other pest repellant.

When the animal repellant is deer repellant, possible repellents include but are not limited to: dryer sheet, blood meal and dried blood, predator urine or feces, mothball flakes, creosote, garlic and rotten eggs, hair, soap, hot pepper, putrid eggs, and thiram.

The basic dryer sheet is an effective deer repellent. The stronger the fragrance on the dryer sheet, the better the effect of repelling the deer. Final Touch®—Spring Fresh Scent is one potentially useful dryer sheet that would be effective. Any sheet treated with scents that are distasteful to deer will be effective, such as Lavender which is a scent found in Arm & Hammer®—Lavender & White Linen®. Bounce®—Outdoor Fresh Scent® is a type of flower scent that will deter deer. Floral scents blend into the garden well and are good deer repellents. Other scents often prove intolerable to deer: Artemisia, lavender, Russian sage, catnip, mint, honeybush, spearmint, tansy, yarrow, thyme, tarragon, oregano, dill, chives.

An organic solution, “Red Alert” repellent may also be used with the present invention. This is an environmentally friendly solution and is being advocated by organic gardeners.

Predator urine or feces can also be used as a repellent, especially from coyotes, bobcats, bears, wolves, lions, tigers, hyenas. Mothball flakes, i.e. naphthalene, is also a well known area repellent, and can be used to deter deer, squirrels, and skunks among other creatures. However, it requires frequent replacement due to it's rapid evaporation and is toxic to humans and pets, so must be used in appropriate areas.

Creosote is another repellent used on utility poles and railroad ties, and works extremely well. On the negative side, it is messy, has an unpleasant odor, (especially in hot weather), must be disposed of in landfills.

Sulfur compounds contained in garlic and fermented solids are highly repellent to deer and other garden pests. Deterrents made from these ingredients are among the most effective scent repellents available.

Oddly, human hair has proved to be an effective deterrent against wild deer. Many urbanized deer, however, are far too sophisticated to be put off by human hair. An artificial plant structure can be designed to open, exposing hair using a cheesecloth/breathable like substance.

Scented bars of soap repel deer. Ammonium soaps of higher fatty acids are effective in repelling deer. Material will be required to prevent soap within the artificial leaf from washing away. Positioning is important. Deer will avoid this odor (by three feet) when feeding.

Another effective manner of repelling animals is to make edible structures that taste bad to the animal. For example, most deer will try several bites of a foul tasting plant before moving on. The artificial leaves can be made and inserted into a plant. The artificial leaves must have an odor that will attract the deer to that particular leaf.

“Hot” tasting leaves not only have a bad taste, but they also will contain an active ingredient called capsaicin, which burns. Capsaicin can repel deer, rabbits, and mice. A mouthful of edible red pepper will not harm the deer, but they find the taste unpleasant. Edible versions should also prove to be effective in deer deterrent. The scent once dried becomes unnoticeable to humans, but the taste remains. Thiram is a fungicide that is distasteful to deer.

In order to camouflage its nature, the full-sized artificial plant 200 may resemble a living plant selected from the group consisting of but not limited to small living plants selected from annuals, biennials, herbaceous perennials, perennial groundcovers, perennial vines, deciduous shrubs, and deciduous trees. Trees can be selected from the group consisting of but not limited to: Arborvitae/white cedar, Viburnum, Birch, Daylilies, Dogwood, Euonymus, Garden lilies, Hydrangea, Impatiens, Linden/basswood, Yews, American Highbush Cranberry, Bush Honeysuckle, Douglas Fir, Forsythia, Hazelnut, Hemlock, Junipers, Maples, Mountain ash, Roses, Spruce, Sumac, Young fruit trees, Ivy, Tulips, Crocus, Daylily, Hosta, Phlox, Azaleas, Lilac, and Hydrangea,

FIG. 2 shows a preferred, alternate embodiment, specifically, an artificial plant portion 310 attached to a living plant portion 370. The artificial plant portion 310 comprises a stem 330 and a leaf 340. The artificial plant portion 310 is attached to the living plant portion 370 by a wire 390. In an alternative embodiment, stem 330 can be flexible, and the flexible stem wraps around the branch of the natural plant. Possible plant portions include but are not limited to portions of the plant selected from the group consisting of at least one stem, at least one leaf, at least one branch, and combinations thereof. The plant portion may be attached to a living plant with a wire stem. The plant portion may be partially made from dryer sheet, and it is especially preferred that the dryer sheet be used to form the artificial leaves. Animal repellant is dispersed over artificial plant portion 310 or substantially all of leaf portion 340. Animal repellant may be dispersed over at least 10%, preferably 50% of the artificial plant portion 310. Animal repellent may be pre-dispersed over the artificial plant portion 310. Additionally the user may apply the animal repellent to the artificial plant portion 310. Methods of user application of animal repellant include but are not limited to spraying, dipping, or painting. The artificial plant portion 310 may be made of edible materials that the pest animals find unpleasant, distasteful or unpleasing to their senses. The animal repellent may be deer repellant as discussed above, or rabbit repellant, fox repellant or rodent repellant. In order to camouflage its nature, the artificial plant portion 310 may resemble the living plant it is intended to protect including those selected from the group consisting of but not limited to small living plants selected from annuals, biennials, herbaceous perennials, perennial groundcovers, perennial vines, deciduous shrubs, and deciduous trees. Deciduous trees may be selected from the group consisting of, but not limited to, Arborvitae/white cedar, Viburnum, Birch, Daylilies, Dogwood, Euonymus, Garden lilies, Hydrangea, Impatiens, Linden/basswood, Yews, American Highbush Cranberry, Bush Honeysuckle, Douglas Fir, Forsythia, Hazelnut, Hemlock, Junipers, Maples, Mountain ash, Roses, Spruce, Sumac, Young fruit trees, Ivy, Tulips, Crocus, Daylily, Hosta, Phlox, Azaleas, Lilac, and Hydrangea.

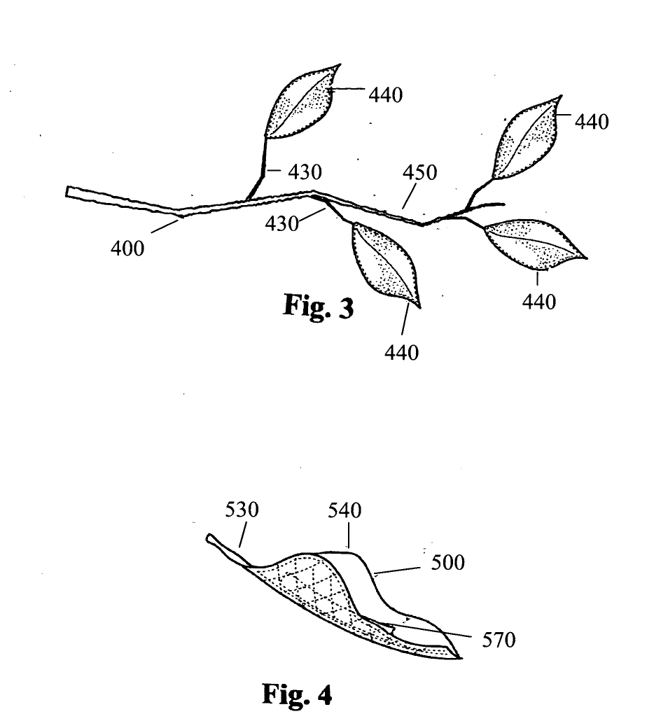

FIG. 3 shows artificial plant portion 400, which comprises a branch 450, and multiple stems 430 and multiple leaves 440. Animal repellant is dispersed over artificial plant portion 400, and more preferably, over multiple leaves 440. The stem design for the artificial plant FIG. 3 can be flexible in order to easily wrap around the living plant it will be attached to, and/or it can be attached with a separate piece of wire or string. FIG. 4 shows an artificial plant portion 500, which comprises a stem 530, a leaf 540 and animal repellant and an absorbent pad 510 for containing animal repellent. The animal repellant 510 may be but is not limited to dryer sheet or similar fibrous substance that is treated to be repellant to pest animals. The leaf 500 may be closed at the factory or store, and then opened by the consumer before use.

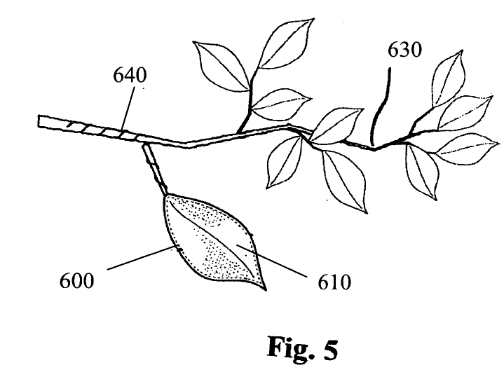

FIG. 5 shows leaf 600 as a single leaf that can be hung off a tree or shrub. The plant portion may be partially made from dryer sheet, and it is especially preferred that the dryer sheet be used to form the artificial leaves. Animal repellant is dispersed over artificial leaf portion 610. Leaf 600 may also have stem 620, which can be hung from natural plant 630 using string or wire 640. Animal repellant may be dispersed over at least 10%, preferably 50% of the artificial leaf portion 610. Animal repellent may be pre-dispersed over the artificial leaf portion 610. Additionally the user may apply the animal repellent to the artificial leaf portion 610. Methods of user application of animal repellant include but are not limited to spraying, dipping, or painting. The artificial plant portion 610 may be made of edible materials that the pest animals find unpleasant, distasteful or unpleasing to their senses. Artificial leaf 610 may be made of a coated wire frame, with dryer sheet or cloth suitable for holding repellent disposed thereon.

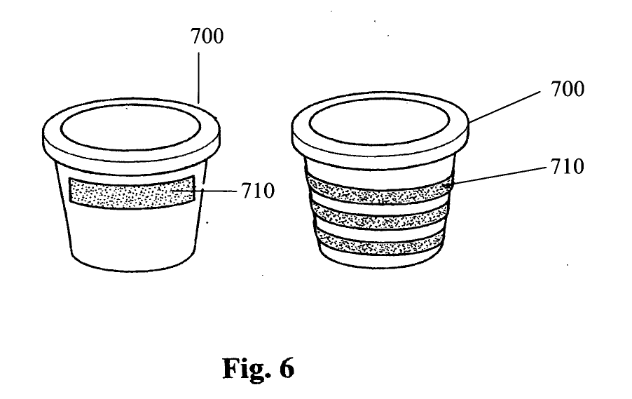

FIG. 6 shows another embodiment of the invention. Band 710 is made from a material suitable for holding animal repellent, and goes part way around, a garden fixture, such as planter 700. The band 710 may be attached to the planter 700 by a variety of methods which include but are not limited to: glued directly to the planter surface, attached by hook and loop fastener, attached by Velcro® (hook and loop fasteners) or be designed with elasticity in order to easily slip on and off planters and or flower boxes. The band could also be integral with the planter 700. The band can be designed to be decorative in nature and can be any size. The band could be used on a variety of fixtures, such as garden chairs, flower boxes, umbrella stands, fence posts, etc.

In another embodiment, the band can be an insect repellent arm band, belt band, hat band. The band could be treated with insect repellent and decorated with child friendly characters plastered across the device. The band could be velcroed or simply tied to a child's belt loop. No more spraying, just pop it out of the box and attach to a child's arm, leg, clothing, or baseball cap.

In additional embodiments the invention can also comprise a garden article such as a garden or landscape flag or windsock, wind chimes, garden mobiles, garden twister balls, windspiners, gazing balls, wind-bells, staked decorative art, spinsocks, twisters, and windsicles, tree ornament/plant or bush ornaments, which can be made of dryer sheet or material suitable for containing animal repellent The band or garden article described above may be made from cloth, paper, plastic, metal, or any combination thereof, so long as at least a portion of the band is suitable for absorbing deer repellent. The animal repellant for the band or garden article may be pre-applied or applied by the user. Methods of user application include but are not limited to spraying, dipping, or painting. The animal repellent may be deer repellant, rabbit repellant, fox repellant, rodent repellant or insect repellant, or other suitable repellant. When the animal repellant is deer repellant possible repellents include but are not limited to: dryer sheet, blood meal and dried blood, predator urine or feces, mothball flakes, creosote, garlic and rotten eggs, hair, soap, hot pepper, putrid eggs, and thiram.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. An article of manufacture, comprising:
an animal repellant dispersed over an artificial plant structure.

2. The article of claim 1 wherein the plant structure is a full-sized artificial plant.

3. The article of claim 1 wherein the artificial plant structure represents a portion of a plant.

4. The article of claim 3 wherein the portion of the plant is selected from the group consisting of at least one stem, at least one leaf, at least one branch, and combinations thereof.

5. The article of claim 1 wherein the animal repellent is dispersed over at least 10% of the plant structure.

6. The article of claim 1 wherein the animal repellent is dispersed over at least 50% of the plant structure.

7. The article of claim 4, wherein the plant portion may be affixed to a living plant.

8. The article of claim 1 wherein the animal repellent is pre-dispersed over the artificial plant structure.

9. The article of claim 1 wherein the animal repellent is sprayed, dipped, or painted onto the artificial plant structure.

10. The article of claim 1 wherein the artificial plant structure is edible.

11. The article of claim 1 where the animal repellent is a deer repellant, rabbit repellant, fox repellant, rodent repellent or insect repellant.

12. The article of claim 1 wherein the animal repellent is a deer repellent, and the animal repellent is selected from the group consisting of: dryer sheet, blood meal and dried blood, predator urine or feces, mothball flakes, creosote, garlic and rotten eggs, hair, soap, hot pepper, putrid eggs and thirma.

13. The article of claim 3 in the plant structure may be attached to a living plant with a wire stem.

14. The article of claim 1 wherein the plant structure is made at least partially from a dryer sheet.

15. The article of claim 1 wherein the plant structure is selected from the group consisting of: annuals, biennials, herbaceous perennials, perennial groundcovers, perennial vines, and deciduous shrubs, arborvitae/white cedar, Viburnum, Birch, Daylilies, Dogwood, Euonymus, Garden lilies, Hydrangea, Impatiens, Linden/basswood, Yews, American Highbush Cranberry, Bush Honeysuckle, Douglas Fir, Forsythia, Hazelnut, Hemlock, Junipers, Maples, Mountain ash, Roses, Spruce , Sumac, Young fruit trees, Ivy, Tulips, Crocus, Daylily, Hosta, Phlox, Azaleas, Lilac, and Hydrangea.

16. An article of manufacture comprising:
a band suitable for wrapping a garden fixture, wherein the band has an animal repellant disposed thereon.

17. The article of claim 16, wherein the garden fixture is a planter.

18. The article of claim 17, wherein the band wraps once around the planter, and the band has a diameter, and the diameter of the band may be adjusted.

19. The article of claim 16, wherein the animal repellent is deer repellent, and is selected from the group consisting of: dryer sheet, blood meal and dried blood, predator urine or feces, mothball flakes, creosote, garlic and rotten eggs, hair, soap, hot pepper, putrid eggs and thirma.

20. The article of claim 16 wherein the animal repellent is sprayed, dipped, or painted onto the band by a user.

21. The article of claim 16 wherein the animal repellent is pre-applied.

22. The article of claim 15, wherein the animal repellent is a deer repellant, a rabbit repellant, fox repellant, rodent repellant or insect repellant.

23. An article of manufacture, comprising:
A garden article having animal repellent disposed thereon.

24. The article of claim 23, wherein the garden article is selected from the group consisting of a flag or windsock.

25. The article of claim 23, wherein the garden article is selected from the group consisting of wind chimes, garden mobiles, garden twister balls, windspiners, gazing balls, wind-bells, staked decorative art, spinsocks, twisters, and windsicles, tree ornament, plant ornament and bush ornaments.
